(19) United States
(12) Patent Application Publication
(10) Pub. No.: US 2025/0162864 A1
(43) Pub. Date: May 22, 2025

(54) METHODS AND SYSTEMS TO PRODUCE HIGH QUALITY SYNGAS FOR THE PRODUCTION OF DIRECT REDUCED IRON (DRI) WHILE MAINTAINING HIGH ENERGY EFFICIENCY

(71) Applicant: Midrex Technologies, Inc., Charlotte, NC (US)

(72) Inventors: Gregory Darel Hughes, Charlotte, NC (US); Todd Michael Astoria, Harrisburg, NC (US); Afsaneh Khajeh, Charlotte, NC (US)

(21) Appl. No.: 18/903,080

(22) Filed: Oct. 1, 2024

Related U.S. Application Data
(60) Provisional application No. 63/599,673, filed on Nov. 16, 2023.

(51) Int. Cl. C01B 3/02; C21B 13/00

(52) U.S. Cl. CPC C01B 3/02; C21B 13/0073; C01B 2203/0205; C01B 2203/06; C01B 2203/085; C21B 2100/22; C21B 2100/40

(57) ABSTRACT

A method and system for producing synthesis gas for the production of direct reduced iron in a direct reduction shaft furnace, including: preheating cold feed gas in a heater to form hot feed gas; adding preheated external hydrogen gas to the hot feed gas downstream of the heater; feeding the hot feed gas and the preheated external hydrogen added to the hot feed gas to a reformer; and reforming the hot feed gas and the preheated external hydrogen added to the hot feed gas in the reformer to form the synthesis gas. The method and system also include feeding the synthesis gas to a bustle of the direct reduction shaft furnace for the production of the direct reduced iron in the direct reduction shaft furnace. The method may include adding preheated external hydrogen gas to the synthesis gas downstream of the reformer and upstream of the direct reduction shaft furnace.

### CROSS-REFERENCE TO RELATED APPLICATION

The present disclosure claims the benefit of priority of co-pending U.S. Provisional Patent Application No. 63/599,673, filed on Nov. 16, 2023, and entitled “METHODS AND SYSTEMS TO PRODUCE HIGH QUALITY SYNGAS FOR THE PRODUCTION OF DIRECT REDUCED IRON (DRI) WHILE MAINTAINING HIGH ENERGY EFFICIENCY,” the contents of which are incorporated in full by reference.

### TECHNICAL FIELD

The present disclosure relates generally to the direct reduced iron (DRI) and steelmaking fields and especially to process efficiency and plant operability. More specifically, the present disclosure relates to methods and systems to produce high quality synthesis gas (syngas) for the production of DRI while maintaining high energy efficiency.

### BACKGROUND

DRI, which is often referred to as sponge iron, is typically produced by the reaction of iron ore in a reactive gas stream containing reducing agents, such as H₂ and CO, in a moving bed or vertical shaft reactor. Such DRI product can be used as a source of low-residual iron, in addition to ferrous scrap and pig iron, in the production of steel, mainly through an electric arc furnace (EAF) in a steelmaking facility.

DRI is a premium ore-based metallic (OBM) raw material that is used to make a wide variety of steel products. As illustrated in FIG. 1, in a direct reduction (DR) process, such as the Midrex® (Kobe Steel, Ltd.) process, iron oxide is reduced to DRI with a hot reducing gas, such as H₂ and CO, in a shaft furnace 11 of a DR plant 10. Top gas 1, containing the reduction products, such as H₂O and CO₂, as well as carried over reactants, such as H₂ and CO, is treated by a top gas scrubber 12 to remove dust and lower the temperature of the top gas 1, which can help control the H₂O content of the top gas 1. Around one-third of the scrubbed gas is discharged and directed to a reformer 17 for use as fuel (top gas fuel) 3 for the reformer 17. The products of combustion are then sent out of the plant 10 through a flue gas stack 14. The remainder of the scrubbed gas 2 is directed to one or more compressors 13. The resulting compressed gas 4 is mixed with natural gas, C_{N}H_{2N+2}, (NG) 5 before being directed to and recycled by the reformer 17.

Normally, the mixed gas 6 (compressed gas 4 and NG 5) is preheated using a tubular heat exchanger 15 before being directed to the reformer 17, which reduces the heat duty of the reformer 17. Likewise, combustion air supplied by an air blower 16 may be preheated using the tubular heat exchanger 26.

The preheated gas mixture exiting the tubular heat exchanger 15 is referred to as feed gas 7. In the reformer 17, C_{N}H_{2N+2} in the feed gas 7 is reformed into CO and H₂ using H₂O and CO₂, as the below reaction equations show, while CO and H₂ carried over in the top gas 1 will be heated passing through the reformer 17. The hot reformed gas 8 is then directed to the DR shaft furnace 11, where the hot reformed gas 8 is used to reduce the iron oxide in an up-flowing manner. Due to the volumetric expansion of the gases that occur during the reforming reactions, the top gas fuel 3 is discharged from the recycle gas loop 9 at the outlet of the top gas scrubber 12.

NH₂O+C_{N}H_{2N+2}→(2N+1)H₂+NCO (endothermic reaction) (1)

NCO₂+C_{N}H_{2N+2}→(N+1)H₂+2NCO (endothermic reaction) (2)

The reformer 17, as a tubular-type reformer, includes a catalyst packed bed inside reformer tubes through which the feed gas 7 passes while the outside of the reformer tubes is externally heated by burners. The reformed gas 8 exiting the reformer 17 is close to an equilibrium condition and the performance of the reformer 17 is mostly restricted by an amount of heat transferred to the feed gas 7 in the reformer tubes.

As part of global efforts to combat climate change, the steel sector seeks to reduce or eliminate its CO₂ emissions. In conventional steelmaking, the largest share of CO₂ emissions originates during the reduction of iron ore, where iron oxide is reduced to metallic iron with coal in the case of a blast furnace and NG in the case of the DR furnace. The input of fossil fuels is used not only to provide the chemistry needed for reduction, but also to supply the energy required for driving the reaction. In the case of DR, it has been determined that hydrogen produced from green sources can serve as a replacement for NG, greatly diminishing emissions during the reduction phase of steelmaking. For this reason, the recent Midrex® DR plant has been designed to be able to replace natural gas (C_{N}H_{2N+1}) with a flexible amount of H₂ according to H₂ availability. This requires operational flexibility to tolerate wider operating conditions under the variable replacement rate by H₂, as addressed by prior U.S. Patent Application Publication No. 2021/0095354.

Thus, the state-of the-art technology includes using heat recovery (HR), which involves the use of the tubular heat exchanger 15 downstream of a Midrex® reformer 17 in FIG. 1 to improve the overall DR energy efficiency. In addition, the HR allows for increased syngas production in the reformer 17 and helps to avoid undesirable side reactions such as carbon deposition.

However, a problem encountered is that the conventional reformer 17 typically operates in a relatively narrow range of operating conditions. In the circumstance where it is necessary to avoid CO₂ emissions by substituting C_{N}H_{2N+1} with externally supplied H₂ gas, the gas composition and flowrates change dramatically. These changes in the gas composition and flowrates reduce the efficiency of the HR because the HR systems have a fixed heat transfer area. Then, when the feed gas flow rates and also the flue gas flow rates change, the temperature of the preheated feed gas 7 is reduced. This reduces the overall plant energy efficiency, and also causes a reduction in the syngas production in the reformer 17, and the lower temperature favors carbon deposition by the Boudouard carbon reaction. The Boudouard carbon reaction can quickly destroy the catalyst in the reformer 17, causing equipment damage and a loss of DRI production.

Thus, what is still needed in the art are DR methods and systems capable of producing high quality syngas for the production of DRI while maintaining high energy efficiency, while also avoiding the undesired and damaging side reaction.

### SUMMARY

Embodiments of the present disclosure address the foregoing needs and others, and improve upon prior methods, systems, and practices of producing syngas for the production of DRI.

Embodiments of the present disclosure solve the foregoing problems by introducing preheated H₂ gas directly into the hot feed gas (HFG) which is preheated with HR and thereafter introduced to the reformer. When the H₂ gas supplies in excess of 30% of the total process fuel and up to 100% of the total process fuel, embodiments of the invention are especially advantageous.

Thus, according to embodiments, the present disclosure provides a method and system for producing reformed gas (syngas) for the DR of iron oxide where a stoichiometric reformer is used to produce the reformed gas, and the feed gas is preheated prior to the reformer using HR to recover heat from the reformer flue gas (combustion products), and the DR process operates continuously across the full range of external fuel sources (from 100% NG to 100% hydrogen).

In some embodiments, the feed gas preheat is maintained above about 500° C. regardless of the external fuel operating condition, and above 40% hydrogen as measured by the total net available heat input of the hydrogen as compared to the total process gaseous fuel requirement.

In some embodiments, the externally supplied hydrogen is heated above about 500° C. and preferably up to about 1000° C.

In some embodiments, the externally supplied hydrogen is introduced into the process downstream of the HR and upstream of the reformer to maintain the feed gas preheat temperature above about 500° C. and preferably up to about 700° C.

In some embodiments, an additional option is to inject the above-referenced preheated hydrogen into the reformed gas, after the hydrogen has been preheated to at least about 700°° C. and preferably up to about 900° C.

In some embodiments, as an additional option, the hydrogen is preheated to at least about 700° C. and preferably up to about 900° C. by an electric heater.

In some embodiments, as an additional option, the hydrogen is preheated to at least about 700° C. and preferably up to about 900° C. by green electricity.

In some embodiments, the present disclosure provides a method for producing synthesis gas for the production of direct reduced iron in a direct reduction shaft furnace, the method including: preheating cold feed gas in a heater to form hot feed gas; adding preheated external hydrogen gas to the hot feed gas downstream of the heater; feeding the hot feed gas and the preheated external hydrogen added to the hot feed gas to a reformer; and reforming the hot feed gas and the preheated external hydrogen added to the hot feed gas in the reformer to form the synthesis gas. The method also includes feeding the synthesis gas to a bustle of the direct reduction shaft furnace for the production of the direct reduced iron in the direct reduction shaft furnace.

In some embodiments, the method includes adding preheated external hydrogen gas to the synthesis gas downstream of the reformer and upstream of the direct reduction shaft furnace. The preheated external hydrogen added to the hot feed gas and the preheated external hydrogen added to the synthesis gas may both be derived from an external hydrogen source and preheated with an external heater. The external heater may be one of a combustion heater, an electric heater, and an electric heater utilizing a green source of electricity.

The cold feed gas may be top gas that is withdrawn from the direct reduction shaft furnace and dedusted/cooled and compressed upstream of the heater.

The heater may be a heat recovery assembly that preheats the cold feed gas to form the hot feed gas using flue gas from the reformer.

In some embodiments, the hot feed gas has a temperature above 500° C., the preheated external hydrogen added to the hot feed gas has a temperature above 500° C. and the preheated external hydrogen added to the synthesis gas has a temperature above 700° C.

In some embodiments, the present disclosure provides a system for producing synthesis gas for the production of direct reduced iron in a direct reduction shaft furnace, the system including: a heater for preheating cold feed gas to form hot feed gas; an external hydrogen source and an external heater for adding preheated external hydrogen gas to the hot feed gas downstream of the heater; and a reformer for receiving the hot feed gas and the preheated external hydrogen added to the hot feed gas and reforming the hot feed gas and the preheated external hydrogen added to the hot feed gas to form the synthesis gas. The system also includes a bustle of the direct reduction shaft furnace for receiving the synthesis gas for the production of the direct reduced iron.

In some embodiments, the system includes an external hydrogen source and an external heater for adding preheated external hydrogen gas to the synthesis gas downstream of the reformer and upstream of the direct reduction shaft furnace. The external hydrogen source and the external heater for adding the preheated external hydrogen gas to the hot feed gas and the external hydrogen source and the external heater for adding the preheated external hydrogen gas to the synthesis gas may be the same external hydrogen source and the same external heater. The external heater may be one of a combustion heater, an electric heater, and an electric heater utilizing a green source of electricity.

The cold feed gas may be top gas that is withdrawn from the direct reduction shaft furnace and dedusted/cooled and compressed upstream of the heater.

The heater may be a heat recovery assembly that preheats the cold feed gas to form the hot feed gas using flue gas from the reformer.

In some embodiments, the hot feed gas has a temperature above 500° C., the preheated external hydrogen added to the hot feed gas has a temperature above 500° C. and the preheated external hydrogen added to the synthesis gas has a temperature above 700° C.

### BRIEF DESCRIPTION OF THE DRAWINGS

The present disclosure is illustrated and described with reference to the various drawings, in which any like reference numbers are used to denote like system/assembly components or method steps, as appropriate, and in which:

FIG. 1 is a schematic diagram illustrating the operation of a DR plant;

FIG. 2 is a schematic diagram illustrating a DR process/system where external H₂ gas is supplied directly to the syngas exiting the reformer;

FIG. 3 is a schematic diagram illustrating a DR process/system where preheated H₂ gas is introduced directly into the hot feed gas (HFG) which is preheated with HR and thereafter introduced to the reformer; and

FIG. 4 is a schematic diagram illustrating a DR process/system where preheated H₂ gas is introduced directly into the reformed gas line, as well as into the HFG; and

FIG. 5 is a flowchart illustrating an embodiment of the DR method/process of the present disclosure.

### DETAILED DESCRIPTION

Embodiments of the present disclosure advantageously improve upon prior methods and systems and produce high quality syngas for the production of DRI while maintaining high energy efficiency. By introducing preheated H₂ gas directly into the HFG, which is preheated with HR and thereafter introduced to the reformer, total burner heat load is reduced, thereby drastically improving reformer operational cost and efficiency, according to embodiments.

Again, embodiments of the present disclosure solve problems in the art by introducing preheated H₂ gas directly into the HFG, which is preheated with HR and thereafter introduced to the reformer; and when the H₂ gas supplies in excess of 30% of the total process fuel and up to 100% of the total process fuel according to embodiments of the present disclosure, such embodiments are particularly suitable and advantageous.

Thus, according to embodiments, the present disclosure provides a method and system for producing reformed gas (syngas) for the DR of iron oxide where a stoichiometric reformer is used to produce the reformed gas, and the feed gas is preheated prior to the reformer using HR to recover heat from the reformer flue gas (combustion products), and the DR process operates continuously across the full range of external fuel sources (from 100% NG to 100% hydrogen).

The H₂ gas can be preheated in any conventional or suitable manner, such as by combustion. For example, the H₂ gas is heated by electrical heating in the temperature range of between about 500° C. to about 1000° C., and then injected into the HFG to control or maintain the temperature to above about 550°° C. and less than about 700° C. This range advantageously allows for the HR design to be simplified, while maintaining high reformer capacity. By heating the H₂ gas by electricity or green electricity, CO₂ emission can be reduced as compared to hydrocarbon combustion. However, significant operating cost savings can also be achieved in comparison to expensive H₂ combustion preheat techniques to preheat the H₂ gas. Examples of green electricity include electricity from, e.g., wind, biomass, solar, geothermal, or other such resources and facilities.

In the conventional reformer, hydrogen is typically not introduced into the feed gas. This is the case because hydrogen is a product of the reforming reactions. It is surprising and counterintuitive to add a product (hydrogen) into the feed gas as described here because, e.g., higher product concentrations in the feed gas will reduce the equilibrium driving force for the reforming reaction to proceed to a lower conversion ratio and reduce the reformed gas quality. However, it has advantageously been determined and verified through testing that by maintaining high enough feed gas preheat temperature as described, any negative effects can be satisfactorily and advantageously overcome.

Another feature of the embodiments of the present disclosure is that the reformer operating cost may be drastically improved under certain circumstances because the total burner heat load is reduced by the additional heater. This advantageously avoids using and introducing expensive H₂ gas to the reformer burners. The reduction in H₂ usage in the burners if the heater is electric. For a combustion-type heater, the reduced heat load in the burners does not result in a significant change in fuel consumption.

Another advantageous embodiment of the present disclosure allows for additional improvement in the DR plant operation by also routing the preheated hydrogen downstream of the reformer into the reformed gas duct.

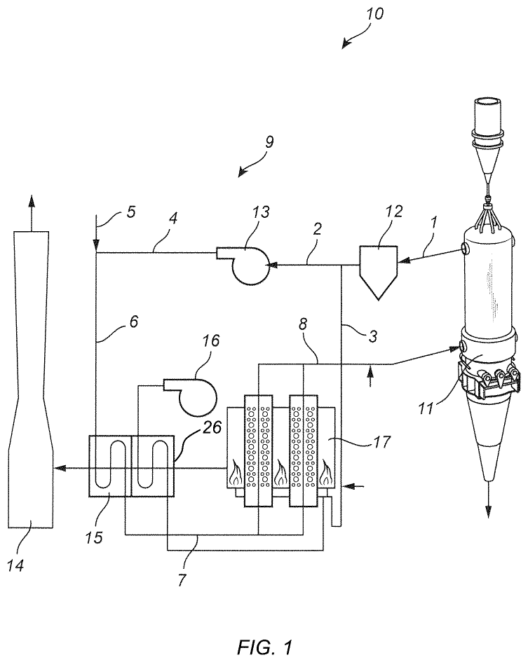

In the conventional technology, the amount of hydrogen introduced into the reformed gas line is limited by the requirement to have high enough temperature at the DR shaft furnace bustle (greater than about 800° C.) in order to have the reduction reactions occur and also maintain high furnace productivity. Hydrogen can be used directly in the reformed gas, but if the temperature is not high enough, then there will not be enough energy to support the reduction reactions. An additional advantage of embodiments of the present disclosure is that the hydrogen can be heated to high enough temperature (greater than about 800° C.) to allow for its direct use in the reformed gas without the disadvantage of lowering the reformed gas temperature. The heating of the external hydrogen also reduces the amount of oxygen injection that is needed to maintain the bustle gas temperature, when utilized in FIG. 1, and results in an additional operating cost savings.

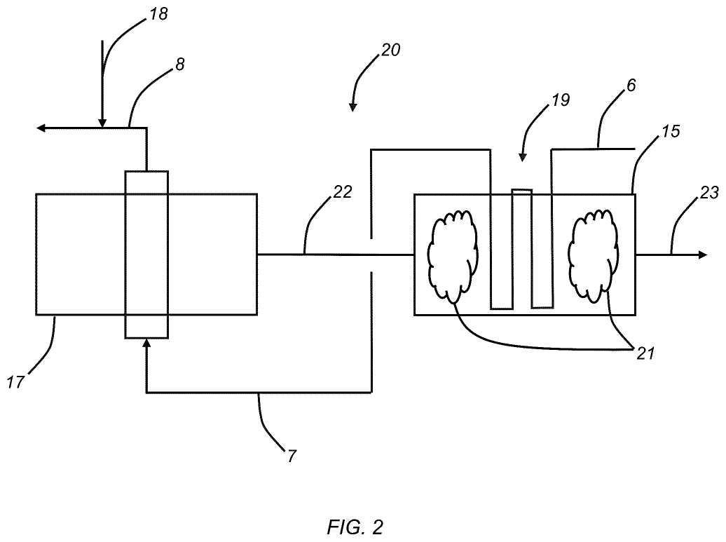

Referring now to FIG. 2, illustrating a DR process/system 20 where external H₂ gas 18 is supplied directly to the syngas 8, feed gas 7 including C_{N}H_{2N+1}, CO₂, and H₂O is processed through the reformer 17 to produce the syngas 8. In particular, cold feed gas 6 enters the HR assembly 19 (including the heat exchangers 15 and/or other preheat bundles or burners 21, such air, top gas feed (TGF), NG, etc.) and the cold feed gas 6 is preheated therein. This HR assembly 19 utilizes flue gas 22 from the reformer 17, as well as an exhaust 23. The preheated gas mixture exits the HR assembly 19 as the preheated feed gas 7 and enters the reformer 17. In the reformer 17, C_{N}H_{2N+2} in the feed gas 7 is reformed into CO and H₂ using H₂O and CO₂. The hot reformed gas 8 is subsequently directed to the DR shaft furnace 11.

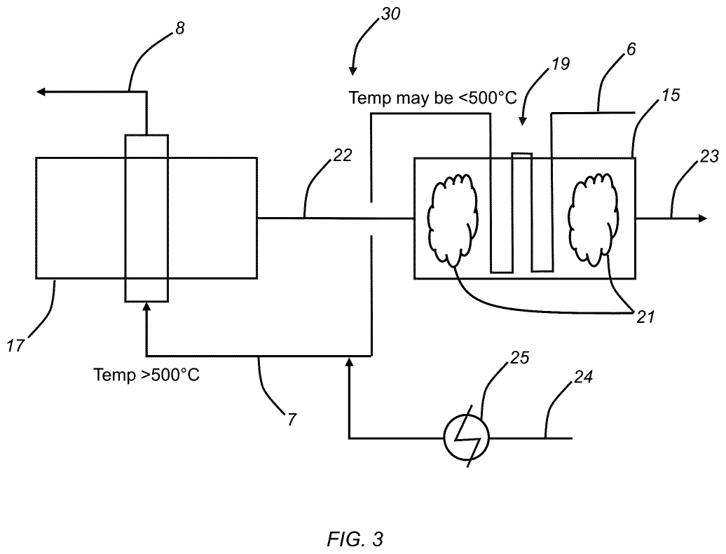

It is noted that the temperature of the HFG 7 needs to remain high enough or else the chemistry of the syngas 8 is negatively affected. Additionally, as more external H₂ gas 18 is injected, the flowrate of the flue gas 22 decreases and the HFG temperature becomes lower. If the temperature is too low, again the syngas chemistry is negatively affected and carbon deposition may undesirably occur in the reformer 17. Accordingly, FIG. 3 below advantageously further addresses these concerns, while noting that external H₂ gas 18 supply directly to the syngas 8 may be used in all embodiments.

Referring now to FIG. 3, similar to FIG. 2, an embodiment of the DR process/system 30 of the present disclosure for producing high quality syngas 8 for the production of DRI includes processing feed gas 7 including CH₄, CO₂, and H₂O through the reformer 17 to produce the syngas 8 including H₂ and CO. Here, cold feed gas 6 enters the HR assembly 19 (including the heat exchangers 15 and/or other preheat bundles or burners 21, such air, TGF, NG, etc.) and the cold feed gas 6 is preheated therein to form the HFG 7. This HR assembly 19 again utilizes flue gas 22 from the reformer 17, as well as an exhaust 23. The preheated gas mixture exits the HR assembly 19 as the preheated feed gas 7 and enters the reformer 17. As shown in FIG. 3, external H₂ gas 24 is preheated with a heater 25 via combustion or electric heating to above about 500° C., such as about 700° C. to about 1000° C., and this preheated H₂ gas 24 is injected directly into the preheated feed gas (the HFG 7) between the HR assembly 19 and the reformer 17.

The preheated H₂ gas 24 advantageously can be injected directly into the HFG 7 due to the increased temperature (preheating) of the H₂ gas 24, and then subsequently enters the reformer 17. The hot reformed gas 8 is subsequently directed to the DR shaft furnace 11. Advantageously, high quality syngas 8 is produced for the production of DRI while maintaining high energy efficiency. It is noted that it is not possible to introduce cold H₂ gas 24 at the location shown in FIG. 3, with the previous technology, due to the associated chemistry limitations.

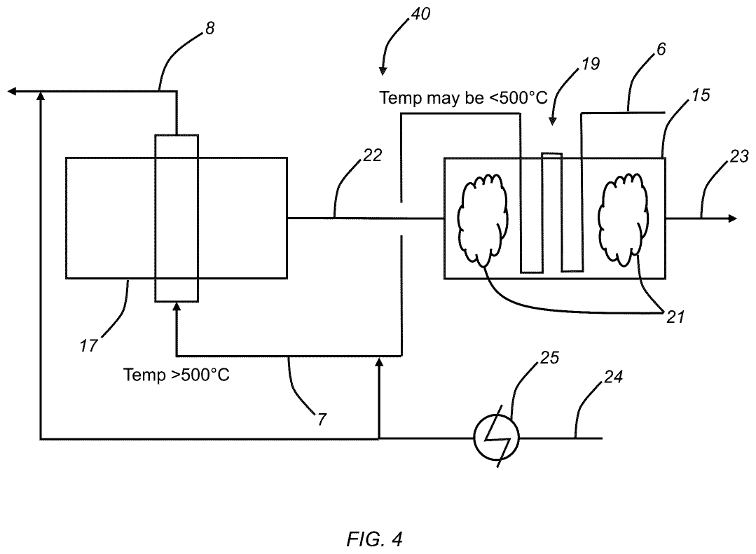

FIG. 4 is a schematic diagram illustrating an embodiment of the DR process/system 40 of the present disclosure similar to FIG. 3, and where the preheated H₂ gas 24 is also introduced directly into the reformed gas line 8.

Thus, according to embodiments, disclosed are methods and systems for producing reformed gas (syngas) for the DR of iron oxide where a stoichiometric reformer is used to produce the reformed gas, and the associated feed gas is preheated prior to the reformer, after dedusting and compression, using HR to recover heat from the reformer flue gas (combustion products), and the DR process operates continuously across the full range of external fuel sources (from 100% NG to 100% hydrogen).

In some embodiments, the feed gas preheat is maintained above about 500° C. regardless of the external fuel operating condition, but preferably above 40% hydrogen as measured by the total net available heat input of the hydrogen as compared to the total process gaseous fuel requirement.

In some embodiments, the externally supplied hydrogen is heated above about 500° C. and preferably up to about 1000° C.

In some embodiments, the externally supplied hydrogen is introduced into the process downstream of the feed gas HR unit and upstream of the reformer to maintain the feed gas preheat temperature above about 500° C., and preferably up to about 700° C.

In some embodiments, an additional option is to inject the above-referenced preheated hydrogen into the reformed gas after the hydrogen has been preheated to at least about 700° C. and preferably up to about 900° C.

In some embodiments, as an additional option, the hydrogen is preheated to at least about 700° C. and preferably up to about 900° C. by an electric heater.

In some embodiments, as an additional option, the hydrogen is preheated to at least about 700° C. and preferably up to about 900° C. by green electricity.

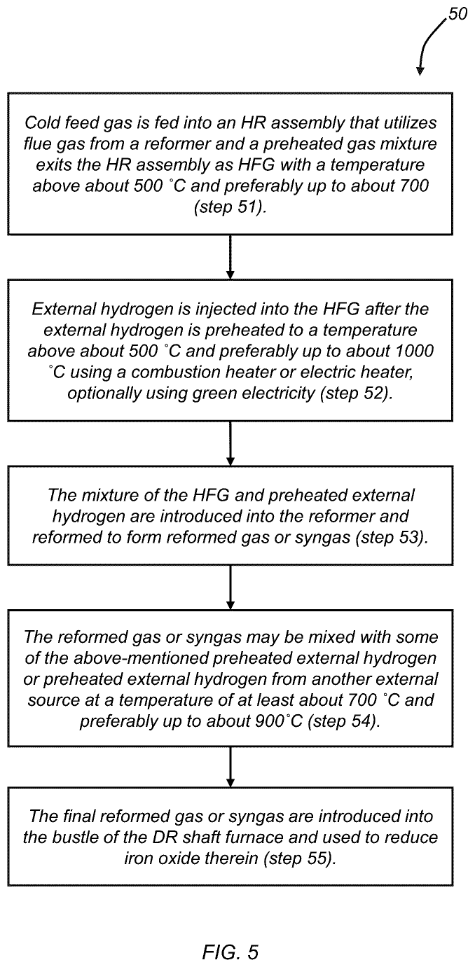

FIG. 5 is a flowchart illustrating an embodiment of the DR method/process 50 of the present disclosure. Pursuant to the method 50, at step 51, cold feed gas optionally consisting of top gas that is withdrawn from a DR shaft furnace and dedusted/cooled and compressed is fed into a heater consisting of a HR assembly such as, e.g., heat exchangers and/or other preheat bundles or burners, such air, TGF, NG, etc. This HR assembly utilizes flue gas from a reformer, as well as an exhaust. The preheated gas mixture exits the HR assembly as HFG with a temperature above about 500° C. and preferably up to about 700° C. At step 52, at this point in the process, external hydrogen is injected into the HFG after the external hydrogen is preheated to a temperature above about 500° C. and preferably up to about 1000° C. using a combustion heater or electric heater, optionally using green electricity. At step 53, the mixture of the HFG and preheated external hydrogen are introduced into the reformer and reformed to form reformed gas or syngas. At step 54, the reformed gas or syngas may be mixed with some of the above-mentioned preheated external hydrogen or preheated external hydrogen from another external source at a temperature of at least about 700° C. and preferably up to about 900° C. At step 55, the final reformed gas or syngas are introduced into the bustle of the DR shaft furnace and used to reduce iron oxide therein.

As noted above, the temperature of the HFG needs to remain high enough or else the chemistry of the reformed gas or syngas is negatively affected. Additionally, as more external H₂ gas is injected after the reformer, the flowrate of the flue gas feeding the HR assembly decreases and the HFG temperature becomes lower. If the temperature is too low, again the reformed gas or syngas chemistry is negatively affected and carbon deposition may undesirably occur in the reformer. Accordingly, the present disclosure advantageously addresses these concerns, by injection preheated hydrogen into the HFG between the HR assembly and the reformer and optionally also downstream of the reformer.

Although the present disclosure is illustrated and described with reference to particular embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes. Moreover, all embodiments, elements, limitations, and features described may be used in any combinations.

What is claimed is:

1. A method for producing synthesis gas for the production of direct reduced iron in a direct reduction shaft furnace, the method comprising:
preheating cold feed gas in a heater to form hot feed gas;
adding preheated external hydrogen gas to the hot feed gas downstream of the heater;
feeding the hot feed gas and the preheated external hydrogen added to the hot feed gas to a reformer; and
reforming the hot feed gas and the preheated external hydrogen added to the hot feed gas in the reformer to form the synthesis gas.

2. The method of claim 1, further comprising feeding the synthesis gas to a bustle of the direct reduction shaft furnace for the production of the direct reduced iron in the direct reduction shaft furnace.

3. The method of claim 2, further comprising adding preheated external hydrogen gas to the synthesis gas downstream of the reformer and upstream of the direct reduction shaft furnace.

4. The method of claim 3, wherein the preheated external hydrogen added to the hot feed gas and the preheated external hydrogen added to the synthesis gas are both derived from an external hydrogen source and preheated with an external heater.

5. The method of claim 4, wherein the external heater comprises one of a combustion heater, an electric heater, and an electric heater utilizing a green source of electricity.

6. The method of claim 1, wherein the cold feed gas comprises top gas that is withdrawn from the direct reduction shaft furnace and dedusted/cooled and compressed upstream of the heater.

7. The method of claim 1, wherein the heater comprises a heat recovery assembly that preheats the cold feed gas to form the hot feed gas using flue gas from the reformer.

8. The method of claim 1, wherein the hot feed gas has a temperature above 500° C. at the reformer.

9. The method of claim 1, wherein the preheated external hydrogen added to the hot feed gas has a temperature above 500° C.

10. The method of claim 3, wherein the preheated external hydrogen added to the synthesis gas has a temperature above 700° C.

11. A system for producing synthesis gas for the production of direct reduced iron in a direct reduction shaft furnace, the system comprising:
a heater for preheating cold feed gas to form hot feed gas;
an external hydrogen source and an external heater for adding preheated external hydrogen gas to the hot feed gas downstream of the heater; and
a reformer for receiving the hot feed gas and the preheated external hydrogen added to the hot feed gas and reforming the hot feed gas and the preheated external hydrogen added to the hot feed gas to form the synthesis gas.

12. The system of claim 11, further comprising a bustle of the direct reduction shaft furnace for receiving the synthesis gas for the production of the direct reduced iron.

13. The system of claim 12, further comprising an external hydrogen source and an external heater for adding preheated external hydrogen gas to the synthesis gas downstream of the reformer and upstream of the direct reduction shaft furnace.

14. The system of claim 13, wherein the external hydrogen source and the external heater for adding the preheated external hydrogen gas to the hot feed gas and the external hydrogen source and the external heater for adding the preheated external hydrogen gas to the synthesis gas are an external hydrogen source and an external heater.

15. The system of claim 11, wherein the external heater comprises one of a combustion heater, an electric heater, and an electric heater utilizing a green source of electricity.

16. The system of claim 11, wherein the cold feed gas comprises top gas that is withdrawn from the direct reduction shaft furnace and dedusted/cooled and compressed upstream of the heater.

17. The system of claim 11, wherein the heater comprises a heat recovery assembly that preheats the cold feed gas to form the hot feed gas using flue gas from the reformer.

18. The system of claim 11, wherein the hot feed gas has a temperature above 500° C. at the reformer.

19. The system of claim 11, wherein the preheated external hydrogen added to the hot feed gas has a temperature above 500° C.

20. The system of claim 13, wherein the preheated external hydrogen added to the synthesis gas has a temperature above 700° C.
